(19) United States
(12) Patent Application Publication
(10) Pub. No.: US 2016/0275595 A1
(43) Pub. Date: Sep. 22, 2016

(54) METHODS AND SYSTEMS FOR RECOMMENDING A TRAVEL ITINERARY

(71) Applicant: MASTERCARD ASIA PACIFIC PTE. LTD., SINGAPORE (SG)

(72) Inventors: Ashutosh Sharan, Gurgaon (IN); Sheetanshu Gupta, Gurgaon (IN); Avyaktanand Tiwary, Gurgaon (IN)

(21) Appl. No.: 15/074,351

(22) Filed: Mar. 18, 2016

(30) Foreign Application Priority Data
Mar. 20, 2015 (SG) 10201502180Y

(51) Int. Cl. G06Q 30/06; G06Q 50/14; G06F 17/30

(52) U.S. Cl. CPC G06Q 30/0631; G06F 17/3053; G06F 17/30241; G06Q 50/14

(57) ABSTRACT

A system comprises a processor; a transactions database comprising transaction records from transactions carried out over a payment network; and a similarity matrix component in communication with the transactions database. The similarity matrix component is configured to cause the processor to: retrieve, from the transactions database, transaction records for payment cards; identify, from the retrieved transaction records, a plurality of merchant identifiers; generate, for each merchant identifier, a merchant vector representing a total number or total value of transactions for the merchant identifier for each of the payment cards; generate, for each geographical location, a geographical location vector representing a total number or total value of transactions for the geographical location for each of the payment cards; compute similarity scores between the merchant vectors and the geographical location vectors; and generate a similarity matrix from the similarity scores.

### FIELD

The present disclosure generally relates to methods and systems for recommending a travel itinerary to a cardholder based on the cardholder's past spending patterns.

### BACKGROUND

This section provides background information related to the present disclosure which is not necessarily prior art.

Recent survey evidence suggests that one of the most stressful challenges for American families planning a vacation is deciding on a destination. A further challenge which causes significant stress is to work out a suitable set of activities at the chosen destination. Partly as a result of these challenges, a significant proportion (about half) of survey respondents say that they wish they could redo a past vacation.

The present disclosure seeks to address one or more of the above challenges.

### SUMMARY

This section provides a general summary of the disclosure, and is not a comprehensive disclosure of its full scope or all of its features. Aspects and embodiments of the disclosure are also set out in the accompanying claims.

Certain embodiments relate to a system comprising: at least one processor; a transactions database comprising a plurality of transaction records from transactions carried out over a payment network, each transaction record comprising data corresponding to: a merchant identifier, an issuer country code, a geographical location and a transaction amount; and a similarity matrix component in communication with the transactions database, the similarity matrix component being configured to cause the at least one processor to: retrieve, from the transactions database, a plurality of transaction records for a plurality of payment cards; generate, from the retrieved transaction records, data corresponding to a plurality of merchant identifiers; generate, for each merchant identifier, merchant vector data representing a total number or total value of transactions corresponding to the merchant identifier for each of the plurality of payment cards; generate, for each geographical location, data corresponding to a geographical location vector representing a total number or total value of transactions for the geographical location for each of the plurality of payment cards; compute similarity score data between the merchant vector data and the geographical location vector data; and generate data corresponding to a similarity matrix from the similarity scores.

Other embodiments relate to a system comprising: at least one processor; a computer-readable storage medium having stored thereon similarity matrix data indicative of one or more similarity matrices, each similarity matrix having rows corresponding to merchants and columns corresponding to geographical locations, each entry of a respective similarity matrix representing a similarity score between a merchant and a geographical location; a transactions database comprising a plurality of transaction records from transactions carried out over a payment network, each transaction record comprising a merchant identifier, an issuer country code, a geographical location and a transaction amount; and a recommendation component in communication with the transactions database and the computer-readable storage medium, the recommendation component being configured to cause the at least one processor to: receive, over a communications network, data indicative of an identifier of a payment card; retrieve, from the transactions database, transaction records matching the identifier of the payment card; and determine, by a collaborative filtering process using the similarity matrix data and the total number or total value of transactions of the matching transaction records, data corresponding to a recommendation score for at least one of the geographical locations.

Further embodiments relate to a computer-implemented method comprising: storing a plurality of transactions in a transactions database, the plurality of transaction records being from transactions carried out over a payment network, each transaction record comprising data corresponding to: a merchant identifier, an issuer country code, a geographical location and a transaction amount; retrieving, by a similarity matrix component from the transactions database, a plurality of transaction records for a plurality of payment cards; generating, by the similarity matrix component from the retrieved transaction records, data corresponding to a plurality of merchant identifiers; generating, by the similarity matrix component for each merchant identifier, merchant vector data representing a total number or total value of transactions corresponding to the merchant identifier for each of the plurality of payment cards; generating, by the similarity matrix component for each geographical location, data corresponding to a geographical location vector representing a total number or total value of transactions for the geographical location for each of the plurality of payment cards; computing, by the similarity matrix component, similarity score data between the merchant vector data and the geographical location vector data; and generating, by the similarity matrix component from the similarity score data, data corresponding to a similarity matrix.

Yet further embodiments relate to a computer-implemented method comprising: storing a plurality of transaction records in a transactions database, the plurality of transaction records being from transactions carried out over a payment network, each transaction record comprising data corresponding to: a merchant identifier, an issuer country code, a geographical location and a transaction amount; providing a computer-readable storage medium having stored thereon similarity matrix data indicative of one or more similarity matrices, each similarity matrix having rows corresponding to merchants and columns corresponding to geographical locations, each entry of a respective similarity matrix representing a similarity score between a merchant and a geographical location; receiving, by a recommendation component over a communications network, data indicative of an identifier of a payment card; retrieving, by the recommendation component from the transactions database, transaction records matching the identifier of the payment card; and determining, by the recommendation component using a collaborative filtering process using the similarity matrix data and the total number or total value of transactions of the matching transaction records, data corresponding to a recommendation score for at least one of the geographical locations.

Further areas of applicability will become apparent from the description provided herein. The description and specific examples and embodiments in this summary are intended for purposes of illustration only and are not intended to limit the scope of the present disclosure. In addition, the above and other features will be better understood with reference to the followings Figures which are provided to assist in an understanding of the present teaching.

### DRAWINGS

The drawings described herein are for illustrative purposes only of selected embodiments and not all possible implementations, and are not intended to limit the scope of the present disclosure.

With that said, embodiments of the present disclosure will now be described, by way of non-limiting example only, with reference to the accompanying drawings in which:

FIG. 1 shows a schematic diagram of a system architecture useful for implementing embodiments of the disclosure;

FIG. 2 is a block diagram of a user device in the system of FIG. 1;

FIG. 3 is a block diagram of a recommendation system in the system of FIG. 1;

FIG. 4 is a flow diagram of a process for generating a similarity matrix according to embodiments of the disclosure;

FIG. 5 is a flow diagram of a process for recommending a travel destination according to embodiments of the disclosure;

FIG. 6 is a flow diagram of a process for location-based recommendation of merchants/services; and

FIG. 7 schematically depicts a similarity matrix generated by embodiments of the disclosure.

Corresponding reference numerals generally indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Embodiments of the present disclosure make use of the insight that if cardholders from a particular geographical region (such as a particular country or region of a country) have historically made purchases with particular merchants and have travelled to a particular destination, then other cardholders from the same region who make purchases at the same merchants but have not previously travelled to that destination will have a higher propensity to travel to the destination. Accordingly, the transaction profile of a cardholder may be used to recommend travel destinations to the cardholder, thereby removing or reducing one of the main causes of stress to the cardholder when planning a vacation.

As used herein, the term “database” may refer to a body of data, a relational database management system (RDBMS), or both. A database may include any collection of data including hierarchical databases, relational databases, flat file databases, object-relational databases, object oriented databases, and any other structured collection of records or data that is stored in a computer system. The above examples are for illustration only, and are not intended to limit in any way the definition and/or meaning of the term database.

As used herein, the terms “payment device,” “transaction card,” “financial transaction card,” and “payment card” refer to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

The systems and processes of the presently described embodiments make use of transaction data representing a plurality of transaction records. The transaction data may be acquired by a payment network (such as a credit card network), during the course of a series of transactions between issuing banks operating accounts on behalf of cardholders, and acquiring banks operating accounts on behalf of merchants.

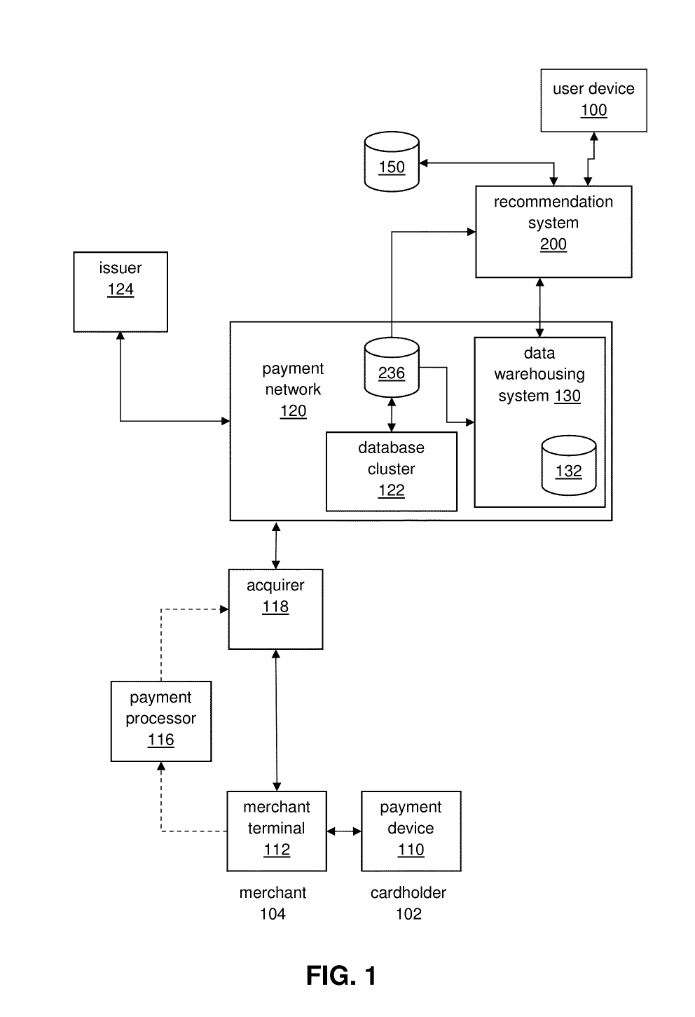

For example, as shown in FIG. 1, a payment processing system comprises a payment network 120, such as the payment networks operated by MasterCard®, Inc. or Visa®, Inc. The payment network 120 acts as an intermediary during a transaction being made by a cardholder 102 using a payment device 110 at a merchant terminal 112 of a merchant 104.

In particular, the cardholder 102 may present payment device 110 to merchant terminal 112 of merchant 104 as payment for goods or services. The merchant terminal 112 may be a point of sale (POS) device such as a magnetic strip reader, chip reader or contactless payment terminal, or a website having online e-commerce capabilities, for example. A merchant 104 may operate one or a plurality of merchant terminals 112. The merchant terminal 112 communicates with an acquirer computer system 118 of a bank or other institution with which the merchant 104 has an established account, in order to request authorization for the amount of the transaction (sometimes referred to as ticket size) from the acquirer system 118. In some embodiments, if the merchant 104 does not have an account with the acquirer 118, the merchant terminal 112 can be configured to communicate with a third-party payment processor 116 which is authorized by acquirer 118 to perform transaction processing on its behalf, and which does have an account with the acquirer entity.

The acquirer system 118 routes the transaction authorization request from the merchant terminal 112 to computer systems of the payment network 120. The transaction authorization request is then routed by payment network 120 to computer systems of the appropriate issuer institution 124 based on information contained in the transaction authorization request. The issuer institution 124 is authorized by payment network 120 to issue payment devices 110 on behalf of cardholder 102 to perform transactions over the payment network 120. Issuer 124 also provides funding of the transaction to the payment network 120 for transactions that are approved.

The computer systems of issuer 124 analyses the authorization request to determine the account number submitted by the payment device 110, and based on the account number, determine whether the account is in good standing and whether the transaction amount is covered by the cardholder's account balance or available credit. Based on this, the transaction can be approved or declined, and an authorization response message transmitted from issuer 124 to the payment network 120, which then routes the authorization response message to the acquirer system 118. Acquirer system 118, in turn, sends the authorization response message to merchant terminal 112. If the authorization response message indicates that the transaction is approved, then the account of the merchant 104 (or of the payment processor 116 if appropriate) is credited by the amount of the transaction.

During each authorization request as described in the previous paragraphs, the payment network 120 stores transaction information in a transactions database 236 accessible via a database cluster 122. The database cluster 122 may comprise one or more physical servers. In some embodiments, the transactions database 236 may be distributed over multiple devices which are in communication with one another over a communications network such as a local-area or wide-area network. In some embodiments, the transactions database 236 may be in communication with a data warehousing system 130 comprising a data warehouse database 132 which may store copies of the transaction data, and/or cleaned and/or aggregated data which are transformed versions of the transaction data. Transaction records (or aggregated data derived therefrom) may be directly accessible for the purposes of performing analyses, for example, by recommendation system 200, from transactions database 236. Alternatively, or in addition, the transaction records (or aggregated data derived therefrom) may be accessed (for example, by recommendation system 200) from the data warehouse database 132. Accessing the transaction records from the data warehouse database 132, instead of the transactions database 236, has the advantage that the load on the transactions database 236 is reduced.

The transaction records may comprise a plurality of fields, including acquirer identifier/card accepter identifier (the combination of which uniquely defines the merchant); merchant category code (also known as card acceptor business code), that is, an indication of the type of business the merchant is involved in (for example, a gas station); cardholder base currency (i.e., U.S. Dollars, Euros, Yen, etc.); the transaction environment or method being used to conduct the transaction; product specific data such as SKU line item data; the transaction type; card identifier (e.g., card number); time and date; location (full address and/or GPS data); transaction amount (also referred to herein as ticket size); terminal identifier (e.g., merchant terminal identifier or ATM identifier); issuer country code; and response code (also referred to herein as authorization code). Other fields may be present in each transaction record.

Each terminal identifier may be associated with a merchant 104, for example, in a merchant database (not shown) of the payment network 120. Typically, a particular merchant 104 will have a plurality of merchant terminal identifiers, corresponding to merchant terminals 112, associated with it.

With continuing reference to FIG. 1, a user device 100 interacts with a recommendation system 200 via a wide area network 220 such as the Internet. The recommendation system 200 may be in communication with the transactions database 236, and/or with the data warehousing system 130. The recommendation system 200 may also communicate with a travel destination database 150 via the wide area network 220 as described in further detail below.

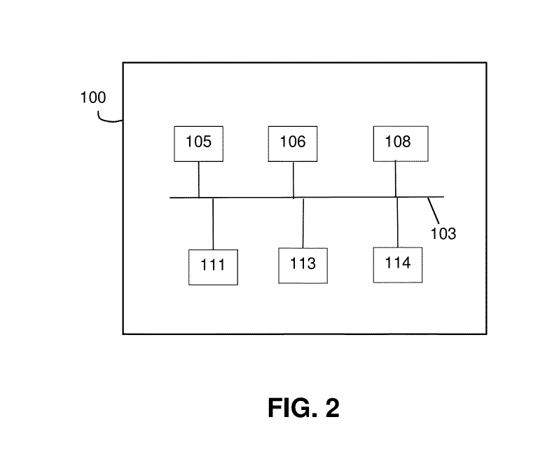

FIG. 2 illustrates a schematic view of an exemplary user device 100. The user device 100 may be, for example, a mobile phone, a tablet, a laptop, a personal computer, or a personal digital assistant (“PDA”). The user device 100 is arranged to receive information from and output information to a user of the user device 100. The user device 100 comprises a central processing unit (“CPU”) or “processing module” 105, a touch screen 106, a memory 108 for storing data, a network interface 111, input devices such as a camera 113 and a microphone 114, and output devices such as speakers 116, all interconnected by a bus 103. The touch screen 106, memory 108, network interface 111, camera 113, microphone 114 and speakers 116 may be integrated into the user device 100 as shown in FIG. 2. In alternative user devices one or more of the touch screen 106, memory 108, network interface 111, camera 113, microphone 114 and speakers 116 may not be integrated into the user device 100 and may be connected to the CPU 105 via respective interfaces. One example of such an interface is a USB interface.

User device 100 interacts with recommendation system 200 via processes executed by the user device 100 which are implemented in the form of programming instructions of one or more software modules or components stored on memory 108 associated with the user device 100. The software modules or components may comprise a web browser component and/or a special purpose software application for receiving input from the user, transmitting it to recommendation system 200, and receiving the results of processing from recommendation system 200 and displaying them to the user on display 106. User device 100 may also have stored, on memory 108, a number of standard modules such as an operating system (e.g., iOS or Android).

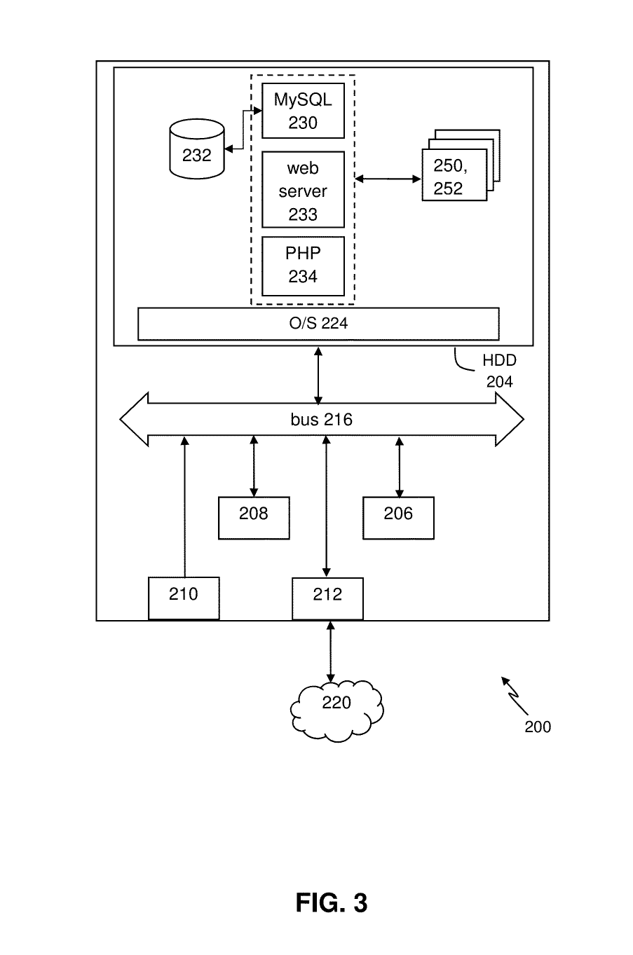

FIG. 3 illustrates an example of a recommendation system 200. In the described embodiment, the recommendation system is a standard computer system such as an Intel® IA-32 based computer system 200, as shown in FIG. 3, and the associated processes executed by the system 200 are implemented in the form of programming instructions of one or more software modules or components, such as a similarity matrix component 250 and a recommendation component 252, stored on tangible and non-volatile (e.g., solid-state or hard disk) storage 204 associated with the computer system 200, as shown in FIG. 3. However, it will be apparent that the processes could alternatively be implemented, either in part or in their entirety, in the form of one or more dedicated hardware components, such as application-specific integrated circuits (ASICs), and/or in the form of configuration data for configurable hardware components, such as field programmable gate arrays (FPGAs), for example.

As will be described in more detail later, similarity matrix component 250 retrieves transaction records from the transactions database 236, and analyses the transaction records to determine a similarity between a merchant at which transactions have been made, and a geographical location at which the transactions have been made. This is repeated for each merchant-geographical location pair for a selected issuer country code in order to generate a similarity matrix for the selected issuer country code. Recommendation component 252 uses the similarity matrix to recommend to a user (at user device 100) matching the selected issuer country code, based on the merchants with which the user has transacted, one or more geographical locations which might be suitable as travel destinations. The similarity matrix component 250 may therefore execute in “off-line” mode, and only require periodic execution as the transactions database 236 is updated, for example, while recommendation component 252 may execute in “on-line” mode in order to provide real-time recommendations to users. Accordingly, although in the embodiment illustrated in FIG. 3, the similarity matrix component 250 and recommendation component 252 are both executed by a single computer system 200, it will be appreciated that in alternative embodiments the recommendation system 200 may comprise a first computer system executing similarity matrix component 250, and a second computer system executing recommendation component 252.

As shown in FIG. 3, the system 200 includes standard computer components, including random access memory (RAM) 206, at least one processor 208, and external interfaces 210, 212, all interconnected by a bus 216. The external interfaces may include universal serial bus (USB) interfaces 210, for example, and a network interface connector (NIC) 212 which connects the system 200 to a communications network 220, such as the Internet.

The system 200 also includes a number of standard software modules, including an operating system 224 such as Linux or Microsoft Windows. The system 200 may include structured query language (SQL) support 230 such as MySQL, available from http://www.mysql.com, which allows data to be stored in and retrieved from an SQL database 232, including output data generated by modules 250, 252. The recommendation system 200 may also include web server software 233 such as Apache, available at http://www.apache.org, and scripting language support 234 such as PHP, available at http://www.php.net, or Microsoft ASP.

Together, the web server 233, scripting language 234, and SQL modules 230 provide the system 200 with the general ability to allow user devices 100 equipped with standard web browser software to access the system 200 and in particular to provide data to and receive data from the database 232.

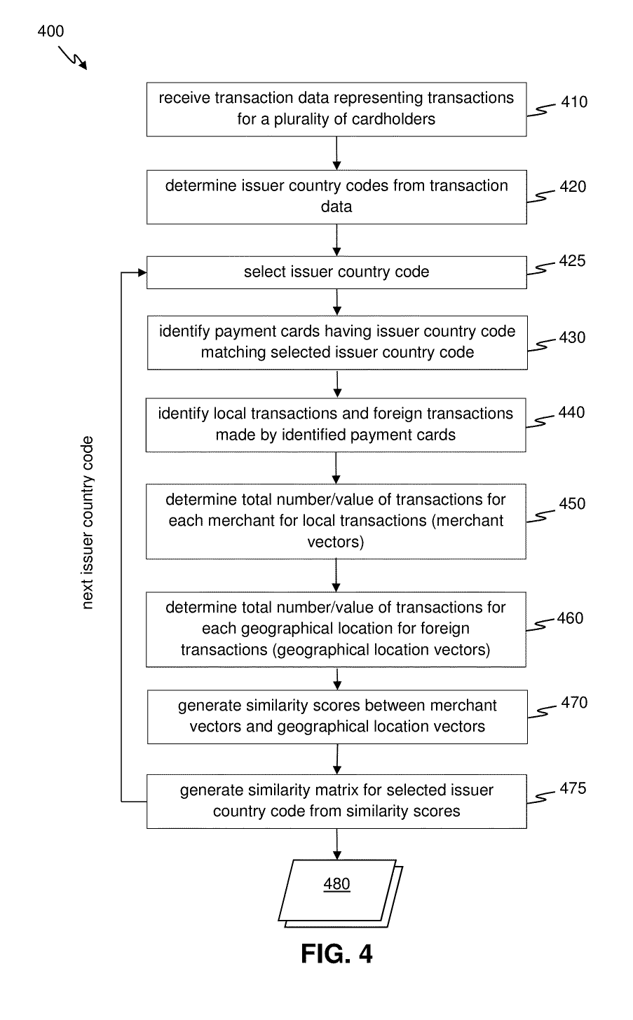

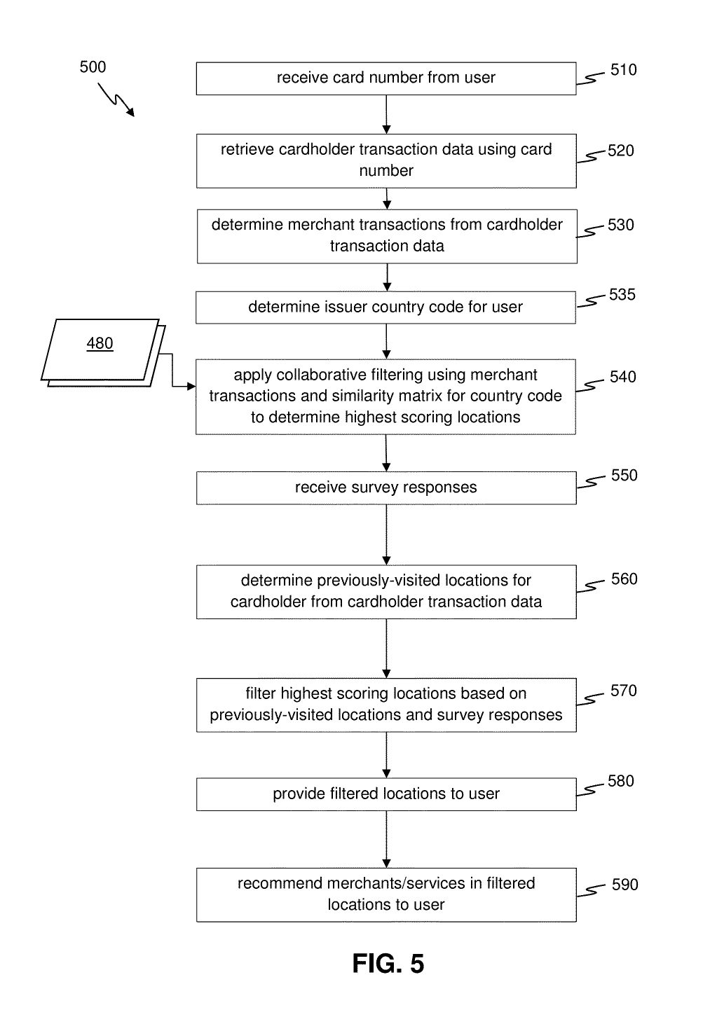

However, it will be understood by those skilled in the art that the specific functionality provided by the system 200 to such users may be provided by scripts accessible by the web server 233, including the software components 250, 252 implementing the processes described below with reference to FIG. 4 and FIG. 5, and also any other scripts and supporting data, including markup language (e.g., HTML, XML) scripts, PHP (or ASP), and/or CGI scripts, image files, style sheets, and the like.

Referring now to FIG. 4, there is shown a flow diagram of an embodiment of a method 400 for generating at least one similarity matrix representing associations between merchants and travel destinations, implemented at least in part by similarity matrix component 250.

At step 410, the similarity matrix component 250 retrieves, from transactions database 236 or data warehouse database 132, transaction data representing a plurality of transaction records for a plurality of payment cards.

At step 420, the similarity matrix component 250 identifies, from the transaction data, a list of issuer country codes associated with the plurality of payment cards.

Next, at step 425, an issuer country code is selected from among the identified issuer country codes from step 420. At step 430, similarity matrix component 250 analyses the transaction data to identify payment cards having an issuer code which matches the selected issuer country code. For example, if the selected issuer country code is “IN”, the similarity matrix component 250 may identify all payment cards issued by Indian issuing banks.

At step 440, transactions made by the payment cards identified at step 430 are analysed by the similarity matrix component 250. In particular, the similarity matrix component 250 determines a geographical location associated with each transaction for a given payment card. For example, a geographical location for a transaction record may be determined by parsing a card acceptor location field of the transaction record to determine a city, state and/or country of the transaction. The similarity matrix component 250 may thereby identify “local” transactions, which are those made with the payment card in the country corresponding to the selected issuer country code, and “foreign” transactions, which are those made in other countries.

Next, at step 450, similarity matrix component 250 determines a merchant name and/or merchant identifier for each local transaction. The total number of purchases, or the total amount of the purchases, for respective merchants for the plurality of payment cards are then calculated, and the calculated values are stored in a merchant vector for each merchant. The similarity matrix component 250 may restrict the analysis to a given time period, for example, to transactions carried out over a period of a year.

At step 460, the foreign transactions (i.e., the transactions which have a geographical location which does not match the selected issuer country code) are analysed by similarity matrix component 250 to determine the total number, or the total value, of transactions for the plurality of payment cards in each geographical location not matching the selected issuer country code. For each geographical location, the transaction values for the plurality of payment cards are stored in a geographical location vector.

At step 470, similarity matrix component 250 computes a similarity score between each merchant and geographical location, using the merchant vectors and the geographical location vectors. The similarity scores between merchants and geographical locations may be stored in a matrix (step 475), as shown in FIG. 7.

In the exemplary similarity matrix 700 of FIG. 7, columns represent merchants ZARA, AUDI and TAJ, and rows represent geographical locations in the form of countries FRANCE, SPAIN and ITALY. The entries of the matrix 700 represent cosine similarity scores between the merchants and the geographical locations. Thus, for example, the entry for the pair ZARA-FRANCE represents the cosine of the angle between the merchant vector for the merchant ZARA and the geographical location vector for the geographical location FRANCE, for a particular issuer country code for which the similarity matrix 700 has been computed.

The similarity score may be a suitably chosen distance or other similarity or difference measure. The similarity measure or difference measure may be chosen according to the nature of the data stored in the respective vectors. For example, if the total number of purchases is stored, then a cosine distance or Manhattan distance may be used. The cosine distance has been found to be particularly useful for analysing total purchases. Other suitable similarity or difference measures may include Euclidean distance or Mahalanobis distance, or a correlation coefficient such as the Pearson correlation coefficient or Kendall's tau.

Once a similarity matrix has been computed for the selected issuer country code at step 475, the process 400 may loop back to step 425 to process the next issuer country code in the list identified at step 420, and continue to iterate until all issuer country codes in the list have been exhausted. Accordingly, process 400 produces a set of similarity matrices 480, one for each issuer country code. Similarity matrix component 250 may store the set of similarity matrices 480 in database 232.

Referring now to FIG. 5, there is shown a process 500 for recommending a travel destination to a cardholder, implemented at least in part by recommendation component 252.

At step 510 the recommendation component 252 receives, via web server 233, a card number of a cardholder from user device 100. The recommendation component 252 then retrieves from transactions database 236 or data warehouse database 132, at step 520, cardholder transaction records for which the card identifier matches the received card number.

At step 530, the recommendation component 252 analyses the retrieved cardholder transaction records (for example, by parsing the records to determine merchant identifiers associated with the records) to determine which merchants the cardholder has conducted transactions at, and merchant transaction data indicative of the total number of transactions or the total value of the transactions at each respective merchant.

At step 540, the list of merchants and the corresponding merchant transaction data can be used by recommendation component 252 to generate a list of recommended travel destinations by a collaborative filtering process using the appropriate similarity matrix 480 computed in process 400.

For example, at step 535, the recommendation module 252 can determine, from the received card number, an issuer country code for the card (for example, from the issuer identification number, IIN), and retrieve from database 232 the similarity matrix 480 corresponding to the issuer country code. The merchant transaction data and the similarity matrix 480 are then used to calculate a recommendation score for each geographical location D_{A} (i.e., each column of the similarity matrix 480) according to:

$$Score ( User - u ) = \frac{{\sum }_{j = 1}^{N} Sim ( {D}_{A} , {M}_{j} ) \times {Txn}_{uj}}{{\sum }_{j = 1}^{N} \vert Sim ( {D}_{A} , {M}_{j} ) \vert} ,$$

where Sim(D_{A}, Mⱼ) is the similarity score (e.g., cosine similarity score) between merchant Mⱼ and geographical location D_{A} from the similarity matrix 480, and Txnᵤⱼ is the transaction value (e.g., total number or value of transactions) at merchant Mⱼ for the user u.

The recommendation scores can then be used to produce a ranked list of geographical locations, with the highest-ranked (e.g., top 5 or top 10) geographical locations being transmitted to user device 100 by web server 233 as recommended travel destinations. In some embodiments, instead of a list of the most highly-ranked geographical locations being recommended, the recommendation module 252 may recommend all geographical locations having a recommendation score which is equal to or greater than some threshold value. In other embodiments, a reduced similarity matrix 480 may be used, for example, by retaining only the rows corresponding to the top-ranked merchants (by total transaction amount or transaction number or frequency), and using only those rows to compute the recommendation scores. For example, the top 50 merchants may be used.

Optionally, the recommendation component 252 may filter the recommended travel destinations according to user input and/or by leaving out destinations which the cardholder has already visited.

For example, at step 550, recommendation component 252 may generate a series of survey questions, transmit them to user device 100 via web server 233, and receive response data indicative of user input constituting responses to the questions. The survey questions may relate to filtering criteria to be applied to the recommended travel destinations. For example, the filtering criteria may include budget, timing, or user travel preferences such as preferred activities.

In some embodiments the filtering criteria may employ travel destination data stored in a travel destination database 150 (FIG. 1) with which the recommendation system 200 is operably coupled. The travel destination data may comprise information such as average cost of accommodations and other services in each geographical location, activities/services which are available in each geographical location and/or within a certain distance of each geographical location, user reviews of merchants and services in respective geographical locations (for example, extracted from review web sites such as expedia.com, tripadvisor.com, yelp.com and the like), and so on. At step 560, the recommendation component 252 may analyse the retrieved cardholder transaction records to determine a list of destinations that the cardholder has visited previously. This can be done at step 430 of process 400, for example, by parsing a card acceptor location field of the transaction record to determine a city, state and/or country of the transaction.

The survey responses from step 550 and/or the previously visited destinations from step 560 may be used by recommendation component 252, at step 570, to filter the recommended travel destinations from step 540. The filtered list can then be transmitted to user device 100 by web server 233 at step 580.

Optionally, at step 590, the recommendation module 252 may query the travel destination database 150, in order to identify highly-ranked merchants or services (based on the user review data stored in the database 150) located at the recommended travel destinations. For example, the recommendation component 252 may retrieve a list of highly-rated hotels based on the user review data, and the web server 233 may transmit these as suggestions to user device 100.

In order to improve performance, recommendation component 252 may store, on storage medium 204, a cardholder profile comprising the retrieved cardholder transaction records and/or data derived from the retrieved cardholder transaction records, such as the list of merchants at which the cardholder has transacted, the geographical locations which the cardholder has previously visited, and any responses to survey questions. In this way, the recommendation component 252, when the user next enters their card number, need not re-execute the entirety of process 500, but can simply retrieve the stored cardholder profile. Further, the cardholder profile may comprise the list of recommended travel destinations from step 540 or 580, and/or the suggested merchants or services from step 590, such that the user can retrieve, via their user device 100, the previously generated suggestions without needing to re-take the survey, for example. The cardholder profile may be stored in the local database 232 of computer system 200, for example.

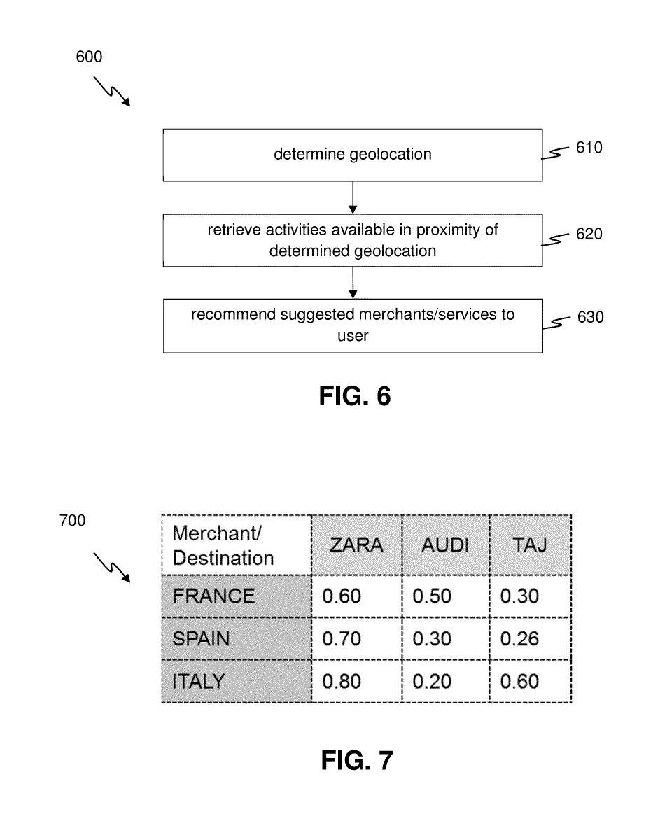

In certain embodiments, recommendation system 200 may further implement a location-based recommendation process, such as process 600 shown in FIG. 6. The process 600 may comprise determining a geolocation of the user (for example, by receiving a geolocation determined by a GPS component of user device 100) at step 610. Next, at step 620, the recommendation component 252 may retrieve a list of activities available within a proximity (e.g., a user-defined proximity) of the determined geolocation, for example, by querying travel destination database 150. At step 630, the recommendation component 252 may determine, for example, by querying the database 150, one or more recommended merchants or services relevant to the list of activities, for example, based on ratings of the merchants or services in the user review data stored in database 150.

Although the present disclosure has been described in accordance with the embodiments shown, one of ordinary skill in the art will readily recognize that there could be variations to the embodiments and those variations would be within the spirit and scope of the present disclosure. Accordingly, many modifications may be made by one of ordinary skill in the art without departing from the spirit and scope of the appended claims.

The functions and/or steps and/or operations included herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Further, it should be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Of course, those skilled in the art will recognize many modifications may be made to this configuration without departing from the scope or spirit of the claimed subject matter.

Moreover, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. As described above, the method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

When a feature is referred to as being “on,” “engaged to,” “connected to,” “coupled to,” “attached to,” “associated with,” “included with,” or “in communication with” another feature, it may be directly on, engaged, connected, coupled, attached, associated, included, or in communication to or with the other feature, or intervening features may be present.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Thus, it will be appreciated that elements of any embodiment disclosed herein may be combined interchangeably with elements of any other embodiment, except where such elements may be mutually exclusive. The above-described embodiments are, therefore, to be considered in all respects to be illustrative and not restrictive.

What is claimed is:

1. A system comprising:
at least one processor;
a transactions database comprising a plurality of transaction records from transactions carried out over a payment network, each transaction record comprising data corresponding to: a merchant identifier, an issuer country code, a geographical location and a transaction amount; and
a similarity matrix component in communication with the transactions database, the similarity matrix component configured to cause the at least one processor to:
retrieve, from the transactions database, a plurality of transaction records for a plurality of payment cards;
generate, from the retrieved transaction records, data corresponding to a plurality of merchant identifiers;
generate, for each merchant identifier, merchant vector data representing a total number or total value of transactions corresponding to the merchant identifier for each of the plurality of payment cards;
generate, for each geographical location, data corresponding to a geographical location vector representing a total number or total value of transactions for the geographical location for each of the plurality of payment cards;
compute similarity score data between the merchant vector data and the geographical location vector data; and
generate data corresponding to a similarity matrix from the similarity score data.

2. The system according to claim 1, wherein the similarity matrix component is configured to retrieve, from the transactions database, a plurality of transaction records for a plurality of payment cards for a selected issuer country code; and to associate the selected issuer country code with the similarity matrix.

3. The system according to claim 2, wherein the similarity matrix data corresponds to a plurality of similarity matrices for a corresponding plurality of issuer country codes.

4. The system according to claim 1, wherein the similarity score data represents cosine similarity scores.

5. The system according to claim 1, wherein the similarity matrix component is configured to, at predetermined intervals, update the similarity matrix data using additional transaction records retrieved from the transactions database.

6. The system according to claim 1, further comprising a recommendation component which is configured to, using the at least one processor:
receive, over a communications network, data indicative of an identifier of a payment card;
retrieve, from the transactions database, transaction records matching the identifier of the payment card; and
determine, by a collaborative filtering process using the similarity matrix data and the total number or total value of transactions of the matching transaction records, data corresponding to a recommendation score for at least one of the geographical locations.

7. (canceled)

8. A system comprising:
at least one processor;
a computer-readable storage medium having stored thereon similarity matrix data indicative of one or more similarity matrices, each similarity matrix having rows corresponding to merchants and columns corresponding to geographical locations, each entry of a respective similarity matrix representing a similarity score between a merchant and a geographical location;
a transactions database comprising a plurality of transaction records from transactions carried out over a payment network, each transaction record comprising a merchant identifier, an issuer country code, a geographical location and a transaction amount; and
a recommendation component in communication with the transactions database and the computer-readable storage medium, the recommendation component configured to cause the at least one processor to:
receive, over a communications network, data indicative of an identifier of a payment card;
retrieve, from the transactions database, transaction records matching the identifier of the payment card; and
determine, by a collaborative filtering process using the similarity matrix data and the total number or total value of transactions of the matching transaction records, data corresponding to a recommendation score for at least one of the geographical locations.

9. The system according to claim 8, wherein respective similarity matrices correspond to respective issuer country codes, and wherein the recommendation component is further configured to: determine, from the data indicative of the identifier of the payment card, an issuer country code of the payment card; and select, from the similarity matrices, a similarity matrix matching the issuer country code of the payment card; wherein the selected similarity matrix is used in the collaborative filtering process.

10. A computer-implemented method comprising:
storing a plurality of transactions in a transactions database, the plurality of transaction records being from transactions carried out over a payment network, each transaction record comprising data corresponding to: a merchant identifier, an issuer country code, a geographical location and a transaction amount;
retrieving, by a similarity matrix component from the transactions database, a plurality of transaction records for a plurality of payment cards;
generating, by the similarity matrix component from the retrieved transaction records, data corresponding to a plurality of merchant identifiers;
generating, by the similarity matrix component for each merchant identifier, merchant vector data representing a total number or total value of transactions corresponding to the merchant identifier for each of the plurality of payment cards;
generating, by the similarity matrix component for each geographical location, data corresponding to a geographical location vector representing a total number or total value of transactions for the geographical location for each of the plurality of payment cards;
computing, by the similarity matrix component, similarity score data between the merchant vector data and the geographical location vector data; and
generating, by the similarity matrix component from the similarity score data, data corresponding to a similarity matrix.

11. The computer-implemented method according to claim 10, wherein retrieving a plurality of transaction records for a plurality of payment cards includes retrieving the plurality of transaction records for a selected issuer country code; and
further comprising associating the selected issuer country code with the similarity matrix.

12. The computer-implemented method according to claim 11, wherein the similarity matrix data corresponds to a plurality of similarity matrices for a corresponding plurality of issuer country codes.

13. The computer-implemented method according to claim 10, wherein the similarity score data represents cosine similarity scores.

14. The computer-implemented method according to claim 10, further comprising updating, by the similarity matrix component, at predetermined intervals, the similarity matrix data using additional transaction records retrieved from the transactions database.

15. The computer-implemented method according to claim 10, further comprising:
receiving, over a communications network by a recommendation component, data indicative of an identifier of a payment card;
retrieving, from the transactions database by the recommendation component, transaction records matching the identifier of the payment card; and
determining, by the recommendation component using a collaborative filtering process using the similarity matrix data and the total number or total value of transactions of the matching transaction records, data corresponding to a recommendation score for at least one of the geographical locations.

16.-18. (canceled)

19. The system according to claim 3, further comprising a recommendation component configured to, using the at least one processor:
receive, over a communications network, data indicative of an identifier of a payment card;
retrieve, from the transactions database, transaction records matching the identifier of the payment card;
determine, by a collaborative filtering process using the similarity matrix data and the total number or total value of transactions of the matching transaction records, data corresponding to a recommendation score for at least one of the geographical locations;
determine, from the data indicative of the identifier of the payment card, an issuer country code of the payment card; and
select, from the plurality of similarity matrices, a similarity matrix matching the issuer country code of the payment card, wherein the selected similarity matrix is used in the collaborative filtering process.

20. The computer-implemented method according to claim 12, further comprising:
receiving, over a communications network by a recommendation component, data indicative of an identifier of a payment card;
retrieving, from the transactions database by the recommendation component, transaction records matching the identifier of the payment card; and
determining, by the recommendation component using a collaborative filtering process using the similarity matrix data and the total number or total value of transactions of the matching transaction records, data corresponding to a recommendation score for at least one of the geographical locations;
determining, by the recommendation component, from the data indicative of the identifier of the payment card, data indicative of an issuer country code of the payment card; and
selecting, by the recommendation component, from the plurality of similarity matrices, a similarity matrix matching the issuer country code of the payment card, wherein the selected similarity matrix is used in the collaborative filtering process.
